(19) United States
(12) Patent Application Publication
(10) Pub. No.: US 2006/0179804 A1
(43) Pub. Date: Aug. 17, 2006

(54) High temperature fabric filter media

(76) Inventor: Robert J. Gerritsen, Burlington (CA)

Correspondence Address: ROBERT J. GERRITSEN, 4539 CONCORD PL., BURLINGTON, ON, L7L-IJ5, CA

(21) Appl. No.: 11/058,262

(22) Filed: Feb. 16, 2005

(51) Int. Cl. B01D 46/00

(52) U.S. Cl. 55/527

(57) ABSTRACT

A fabric filter media resistant to high temperatures and method for making same which includes forming a circular knit fabric from Basalt continuous fibers; having the particular characteristics and effective for separating particulates from high temperature gas streams.

### BACKGROUND OF INVENTION

Many industrial processes create dust and other particulate matter that is not permitted to be released to the atmosphere, must be removed to prevent damage to downstream equipment or can be reclaimed because of its commercial value. Technology must be deployed to capture the dust and particulate, to prevent atmospheric pollution, to eliminate process contamination and enhance profits with the added revenue from recovered material.

Dust collectors with fabric filters are one of these technologies and are suitable for high efficiency (<10 μm) particulate removal. Traditionally, conventional dust collectors have been limited to a maximum 500° F. continuous operating temperature due to the limitations of the fabric filter media available.

For processes operating over 500° F., of which there are many in cement, metallurgical, waste incineration and power generation, high temperature gas streams must be cooled to below 500° F.

Cooling is typically accomplished by the addition of dilution air, spray cooling or mechanical chilling. All these techniques add complexity and increase both operating and capital costs.

Care must also be taken where high temperature, acidic-gas streams are cooled or are allowed to fall below the due point of the acid gas causing condensation of the acid and equipment corrosion and failure.

The cost and operational advantages offered by a fabric filter media capable of operating continuously over 500° F., within conventional air pollution control systems is substantial, both in terms of decreased capital and operating costs, and environmental impact.

### BRIEF SUMMARY OF INVENTION

The object of the present invention is to provide a fabric filter media capable of separating particulate from high temperature gas streams. The filter media in accordance with the present invention comprises of a circular knitted Basalt fabric, having certain characteristics pointed out herein.

### DETAILED DESCRIPTION & PREFERED EMBODIMENTS OF INVENTION

Conventional fabric filter media is limited to a maximum 500° F. continuous operating temperature due to the limitations of the fiber available. Basalt fiber has a maximum continuous operating temperature in process gas streams of over 1000° F.

Basalt fiber has similar mechanical properties to fiberglass and can be similarly processed into a filter media by weaving or knitting. Circular knitting is the preferred method for this invention thereby eliminating the longitudinally seam and the expense and problems of sewing the seam.

Continuous Basalt fiber having a filament diameter in the range of about 9 to about 300 microns is available from numerous suppliers.

In order to provide adequate filtration performance, the Basalt fabric media is knitted where the stitches defining open areas are in the range of about 1 to about 100 microns.

Since dust collector designs vary widely, circular knitting of a preset diameter and cutting and sewing to a preset length are another variant of this invention.

Yet another variant of this invention is to slit the preset diameter into a flat web that will allow sewing of filter bags of varied diameters and designs.

A final variant of the invention is to slit the preset diameter into a flat web that will allow the construction of pleated panel filters and cartridge filters.

The specifications herein set forth a preferred embodiment of the invention and although specific terms are employed, they are used in a generic and descriptive sense only and not for the purpose of limitation.

### REFERANCES CITED

U.S. Patent Documents

| | | | |
|---|---|---|---|
| 6,036,739 | March, 2000 | New | 55/527. |
| 5,230.226 | July, 1993 | Saarikettu | 66/202. |
| 4,284,507 | August, 1981 | Beane | 210/435. |
| 4,181,514 | January, 1980 | Leftowitz | 55/488. |

What is claimed is:

1. A method for making Basalt fabric filter media comprising of circularly knit Basalt fiber having a filament diameter in the range of about 9 to about 300 microns, knitted into a tube of preset diameter where the stitches defining open areas are in the range of about 1 to about 100 microns.

2. A method according to claim 1 wherein the tube of preset diameter is cut into preset lengths and then sewing the fabric into a bag by closing one end.

3. A method according to claim 1 wherein the step of knitting comprises forming the Basalt fiber into stitches and into courses having from about 8 to about 13 stitches per centimeter.

4. A method according to claim 1 wherein the tube of preset diameter can be slit and opened creating a flat web, and then sewing the flat web fabric into a closed end tube of preset diameter and preset length.

5. A fabric filter media according to claim 1, wherein the fabric filter media is formed from Basalt fiber having a filament diameter in the range of about 9 to about 300 microns.

6. A fiber according to claim 5, wherein the fiber is a continuous filament drawn or extruded from Basalt rock, comprising chiefly of plagioclase, pyroxene and olivine.

7. A fiber according to claim 5, wherein the fiber is a roving formed of twister Basalt continuous filaments with a linear density of about 330+/−10% Tex.
